(19) United States
(12) Patent Application Publication
(10) Pub. No.: US 2005/0104921 A1
(43) Pub. Date: May 19, 2005

(54) Drive waveform-determining device, electrooptical device, and electronic equipment

(75) Inventors: Nobuko Watanabe, Kanazawa-shi (JP); Hirotsuna Miura, Nagano-ken (JP)

Correspondence Address: SHINJYU GLOBAL IP COUNSELORS, LLP, 1233 20TH STREET, NW, SUITE 700, WASHINGTON, DC, 20036-2680, US

(73) Assignee: Seiko Epson Corporation, Shinjuku-ku (JP)

(21) Appl. No.: 10/783,094

(22) Filed: Feb. 23, 2004

(30) Foreign Application Priority Data
Feb. 25, 2003 (JP) JP 2003-048146
Dec. 9, 2003 (JP) JP 2003-410555
Feb. 12, 2004 (JP) JP 2004-035541

(51) Int. Cl. B41J 29/38

(52) U.S. Cl. 347/19

(57) ABSTRACT

A drive waveform-determining device is configured and arranged to determine an exact drive waveform for a droplet discharge device with minimal trials. The drive waveform-determining device uses an analysis unit that stores optimal weight and velocity for droplets, and basic configurations of drive waveforms. A weight- and viscosity-determining unit measures the weight of droplets discharged from a discharge head. The analysis unit measures the velocity of the droplets with the aid of a CCD camera and a strobe light. The analysis unit reads a basic configuration of a drive waveform and adjusts the drive waveform so that the measured weight and velocity match the weight and velocity stored in the analysis unit. The analysis unit then stores the adjusted drive waveform.

### BACKGROUND OF THE INVENTION

1. Field of the Invention

The present invention relates to a technique for determining a drive waveform for driving a discharge head of a droplet discharge device.

2. Background Information

Droplet discharge devices are conventionally used for discharging and depositing droplets on an object medium. In such a droplet discharge device, a unit filled with a liquid is caused to contract and expand as a result of expansion and contraction being induced in a piezoelectric element by the application of voltage. The droplet discharge device thereby discharges droplets from discharge openings in the droplet discharge head. An example of an application for this droplet discharge device includes formation of wiring on circuit boards for electronic equipment. The process is performed by discharging a liquid material containing dispersed conductive particles onto a board.

Various liquid materials are used in industrial applications of droplet discharge devices, and the density, viscosity, and other characteristics differ for each material. Because the discharge condition of droplets (the quantity in one drop, the velocity, and the like) change according to the characteristics of the liquid material, the waveform of the drive voltage that is applied to the piezoelectric element must be adjusted for each liquid material so that an optimal discharge condition is always maintained.

Technology aimed at controlling such droplet discharge conditions has been proposed as for example in Japanese Laid-Open Patent Publication No. 11-309872. The technology disclosed in Japanese Laid-Open Patent Publication No. 11-309872 stabilizes the quantity of ink discharged by changing the drive voltage waveform (hereinafter referred to as drive waveform) in accordance with the quantity of ink remaining inside the ink cartridge.

It has been discovered that determining the drive waveform conventionally entails trial and error while measuring the weight, flying speed, and other properties of droplets discharged on a trial basis. As a result, a long period of time is required to determine the drive waveform, and a considerable amount of liquid material is consumed in order to determine the drive waveform, resulting in considerable cost increases.

In view of the above, it will be apparent to those skilled in the art from this disclosure that there exists a need for an improved technique for determining the optimal drive waveform for driving a discharge head of a droplet discharge device. This invention addresses this need in the art as well as other needs, which will become apparent to those skilled in the art from this disclosure.

### SUMMARY OF THE INVENTION

One object of the present invention is to provide a technology that is capable of determining an exact drive waveform for a droplet discharge device with few trials.

In order so solve the above-mentioned problems, the present invention provides a drive waveform-determining device comprising a condition storage section, a weight measuring section, a speed-measuring section, a basic drive waveform storage section, a waveform-adjusting section and an adjusted waveform storage section. The condition storage section is configured and arranged to store an optimal weight and velocity of the droplets to be discharged from a discharge head. The weight measuring section is configured and arranged to measure the weight of the droplets discharged from the discharge head. The speed-measuring section is configured and arranged to measure the velocity of the droplets discharged from the discharge head. The basic drive waveform storage section is configured and arranged to store a basic drive waveform. The waveform-adjusting section is configured and arranged to read the basic drive waveform from the basic drive waveform storage section and adjust the basic drive waveform to an adjusted drive waveform so that the weight that is measured by the weight measuring section and the velocity that is measured by the speed-measuring section substantially match the optimal weight and velocity that are stored in the condition storage section for the adjusted drive waveform. The adjusted waveform storage section is configured and arranged to store the adjusted drive waveform that is adjusted by the waveform-adjusting section.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a schematic diagram showing a structure of a drive waveform-determining device in accordance with the present invention;

FIG. 2 is a schematic diagram showing a structure of a weight and viscosity measuring unit in accordance with the present invention;

FIG. 3 is a schematic diagram showing a structure of a sensor chip in accordance with the present invention;

FIG. 4 is a schematic diagram showing a structure of a weight and viscosity measuring unit in accordance with the present invention;

FIG. 5 is a flow chart showing a control process for determining a drive waveform in accordance with the present invention;

FIG. 6 is a diagram showing an example of a basic drive waveform in accordance with the present invention;

FIG. 7 is a chart showing the manner in which the droplet velocity varies when a hold time Pwh1 is changed in accordance with the present invention;

FIG. 8 is a diagram showing an example of a drive waveform used when determining parameter Ta in accordance with the present invention;

FIG. 9 is a chart showing the manner in which the droplet velocity varies when a hold time w is changed in accordance with the present invention;

FIG. 10 is a series of diagrams showing an example of a basic drive waveform created with the aid of parameters Tc and Ta in accordance with the present invention;

FIG. 11 is a chart showing the relationship between the hold time Pwh1 and the relative variation in accordance with the present invention;

FIG. 12 is a chart showing the relationship between the frequency of the drive voltage and the weight of a discharged droplet in accordance with the present invention;

FIG. 13 is a chart showing the relationship between δIw and the hold time Pwh2 in accordance with the present invention;

FIG. 14 is a chart showing the relationship between the weight Iw of a droplet and the hold time Pwh2 in accordance with the present invention;

FIG. 15 is a chart showing the relationship between the highest electric potential VH and the droplet velocity vm in accordance with the present invention;

FIG. 16 is a chart showing the relationship between the normal electric potential VC and the weight Iw of the droplet in accordance with the present invention;

FIG. 17 is a chart showing the relationship between the highest electric potential VH and the weight Iw of a droplet in accordance with the present invention;

FIG. 18 is a simplified perspective view of an example of a droplet discharge device in accordance with the present invention;

FIG. 19 is a cross-sectional view of an electrooptical device having a color filter in accordance with the present invention; and

FIG. 20 is a perspective view of a portable telephone equipped with the electrooptical device in accordance with the present invention.

### DETAILED DESCRIPTION OF THE PREFERRED EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

### Structure of Drive Waveform Device

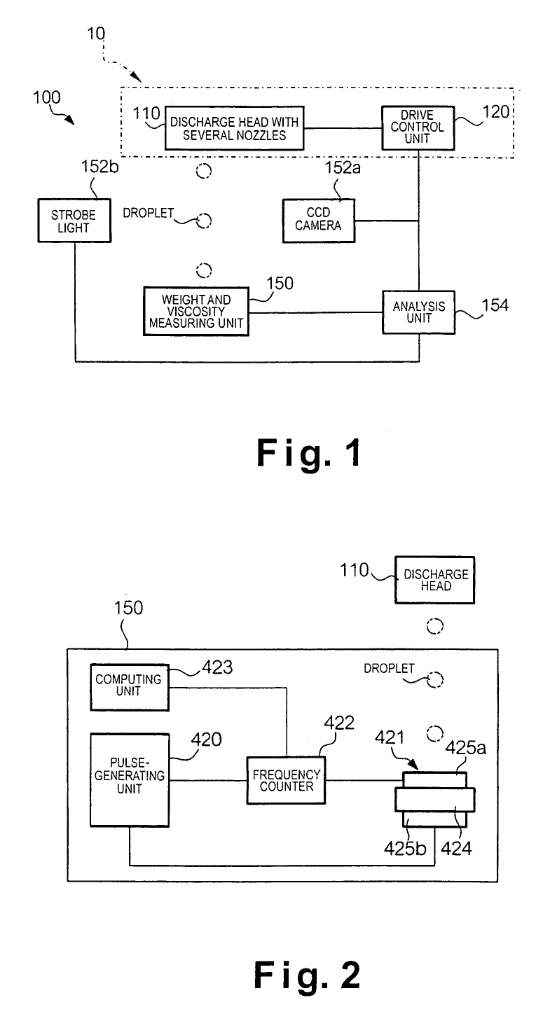

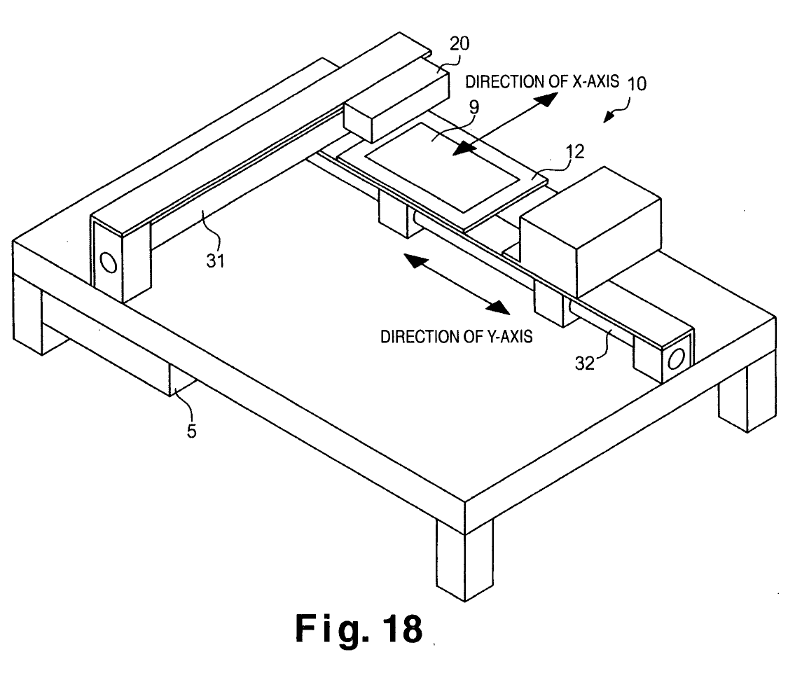

Referring initially to FIG. 1, a drive waveform-determining device 100 is illustrated in accordance with a first embodiment of the present invention. The drive waveform-determining device 100 is a device for determining a drive waveform of a discharge head 110 in a droplet discharge device 10 (See FIG. 18) for forming a conductive film pattern on a board by discharging liquid material in which silver particles are dispersed in a C₁₄H₃₀ (tetradecane) solvent onto a prescribed position on the board.

The drive control unit 120 supplies the drive waveform for driving the discharge head 110 to discharge droplets. The discharge head 110 has a liquid-filled unit (not depicted in detail) equipped with a piezoelectric element, such that the volume of the liquid-filled unit is caused to expand or contract as a result of expansion or contraction being induced in the piezoelectric element by this drive waveform. The discharge head 110 thereby forms the liquid material into droplets and discharges the droplets toward the board to be coated with the liquid material. The discharge head 110 also preferably has a plurality of nozzles (only one stream of droplets is shown in FIG. 1).

The analysis unit 154 is a computer device or control unit that preferably includes a microcomputer or a central processing unit (CPU) that controls the components of the drive waveform-determining device 100 when the CPU executes a computer control program as discussed below. The analysis unit 154 preferably includes other conventional components such as an input interface circuit, an output interface circuit, and storage devices such as a ROM (Read Only Memory) device with the computer control program stored therein and a RAM (Random Access Memory) device that stores statuses of operational flags and various control data. It will be apparent to those skilled in the art from this disclosure that the precise structure and algorithms for analysis unit 154 can be any combination of hardware and software that will carry out the functions of the present invention. In other words, “means plus function” clauses as utilized in the specification and claims should include any structure or hardware and/or algorithm or software that can be utilized to carry out the function of the “means plus function” clause.

Thus, these components (CPU, ROM and RAM) of the analysis unit 154 are configured and arranged to form a condition storage section, a basic drive waveform storage section, a waveform-adjusting section, and an adjusted waveform storage section. The condition storage section is configured and arranged to store an optimal weight and an optimal velocity of the droplets to be discharged from a discharge head. The basic drive waveform storage section is configured and arranged to store a basic configuration of the drive waveform. The waveform-adjusting section is configured and arranged to read the basic drive waveform from the basic drive waveform storage section and adjust the basic drive waveform to an adjusted drive waveform so that the weight that is measured by the weight measuring section and the velocity of droplet that is measured by the speed-measuring section substantially match the optimal weight and velocity of droplet that are stored in the condition storage section for the adjusted drive waveform. The adjusted waveform storage section is configured and arranged to store the adjusted drive waveform that is adjusted by the waveform-adjusting section.

The analysis unit 154 correlates the optimal weight and the optimal velocity of the droplets with the type, physical property values, and temperature of the liquid material, and stores the data. The analysis unit 154 makes a determination as to whether or not the weight and velocity of the droplets discharged from the discharge head substantially or exactly match the stored values, and determines an optimal drive waveform. The analysis unit 154 further correlates the determined drive waveform with the type, physical property values, and temperature of the liquid material, and stores the data. The procedures performed by the analysis unit 154 are described hereinafter.

Viscosity is used as a physical property value of the liquid material in the present embodiment, but surface tension, contact angle, density, and other physical property values can also be used as a physical property value of the liquid material in the present embodiment.

The weight and viscosity measuring unit 150 is a QCM (Quartz Crystal Micro balance) that is configured and arranged for measuring the weight of droplets using the change in the resonance frequency when a droplet deposits on a quartz oscillator, and functions as the weight measuring section and the physical property value measuring section. The weight measuring section is configured and arranged to measure the weight of the droplets discharged from the discharge head 10. The physical property value measuring section is configured and arranged to measure these physical property values of the droplet when surface tension, contact angle, density, and other physical property values are used as the physical property values of the liquid material. The weight and viscosity measuring unit 150 constitutes the physical property value acquisition section (the weight and viscosity measuring unit 150) for acquiring the physical property values of droplets discharged from the discharge head 110, wherein the basic drive waveform storage section stores a plurality of drive waveforms that correspond to the physical property values of the droplets.

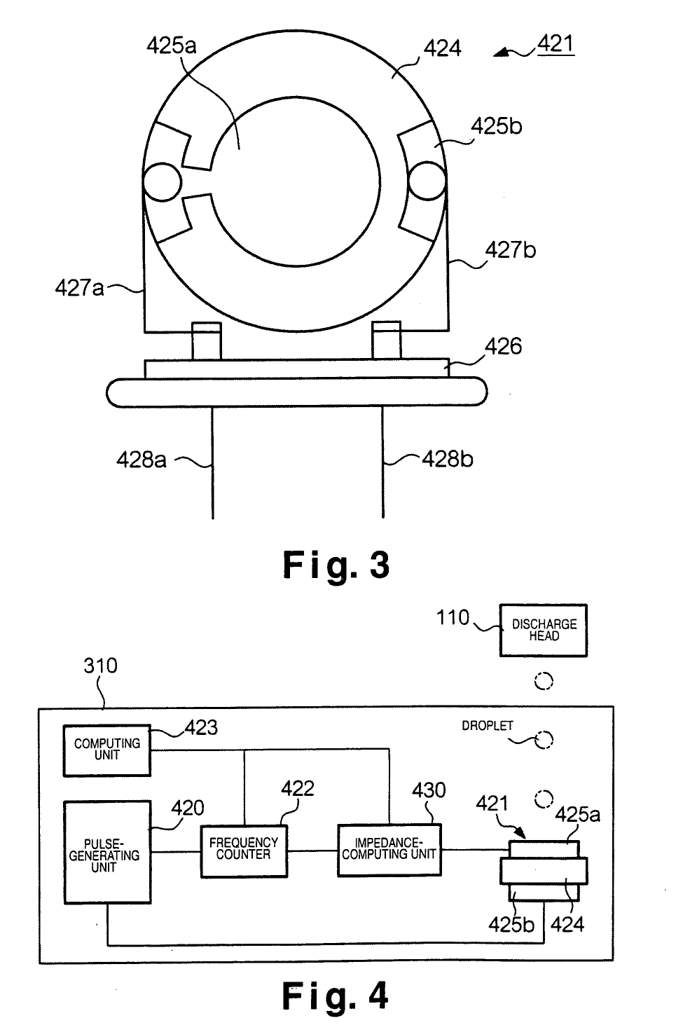

FIG. 2 is a schematic diagram showing the structure of the weight and viscosity measuring unit 150. The constituent components of the weight and viscosity measuring unit 150 primarily include a sensor chip 421, a frequency counter 422, a computing unit 423, and a pulse-generating unit 420. FIG. 3 is a schematic diagram showing the structure of the sensor chip 421. The diagram of FIG. 3 shows the surface of the sensor chip 421 that faces the discharge head 110. A pair of electrodes 425a and 425b is mounted facing both sides of the quartz oscillator 424. An insulator 426 holds the quartz oscillator 424 in a freely oscillating manner by way of a pair of conductive supports 427a and 427b. The support 427a is conductive with respect to the electrode 425a and with respect to a terminal 428a, which is fixed to the insulator 426. The support 427b is conductive with respect to the electrode 425b and with respect to a terminal 428b, which is fixed to the insulator 426. With the above-described structure, the quartz oscillator 424 oscillates at a resonance frequency when a pulse signal that is output from the pulse-generating unit 420 is input to the sensor chip 421 by way of the terminals 428a and 428b.

The sensor chip 421 is configured such that the electrode 425a thereof faces the droplet discharge surface of the discharge head 110. When a droplet discharged from the discharge head 110 deposits on the electrode 425a, the mass of the deposited droplet is calculated by the weight and viscosity measuring unit 420.

The quartz oscillator 424 oscillates at a fixed resonance frequency if the external force acting thereon remains constant, but the quartz oscillator has a characteristic whereby if a substance deposits on the surface of the electrode 425a and the external force changes, then the resonance frequency changes in accordance with the quantity of the change. In the case that the deposited substance has viscoelasticity, the resonance frequency of the quartz oscillator 424 changes in accordance with the characteristic value of the viscoelasticity of the substance.

Thus, the weight measuring section of the weight and viscosity measuring unit 150 preferably comprises the electrode 425a disposed so as to face the discharge head 110, the quartz oscillator 424 for changing the frequency in accordance with the weight of a substance deposited on the electrode surface, the frequency counter 422 for measuring the frequency of the oscillator, and the computing unit 423 as a calculating section for calculating the weight of the droplets on the basis of the difference in frequency before and after droplet deposition measured with the aid of the frequency counter 422. According to the above-described structure, the weight of the droplets can be accurately measured, and an optimal drive waveform can be determined in order to allow droplets having a desired weight to be discharged.

Described here is the measurement of a droplet weight. To exclude the effect of the droplet's viscoelasticity, the measurement of the droplet weight is performed after the droplet is dried and the solute precipitated. The frequency counter 422 detects the resonance frequency of the quartz oscillator 424 on which the precipitate deposits, and supplies a signal that shows the detection result to the computing unit 423. Here, the relationship between the resonance frequency and the weight of a substance deposited on a quartz oscillator is known in advance. When the computing unit 423 receives a signal showing the resonance frequency that is output from the frequency counter 422, the signal is used to compute the weight of the precipitate. The weight of the droplet prior to drying is computed from the weight of the precipitate and the concentration of the liquid material. A quartz crystal is used in the present embodiment, but a piezoelectric element, a magnetostrictive element, or the like can be used.

The following methods can be used to measure the weight of a droplet.
(a) Collection Method—The collection method entails discharging a droplet a fixed number of times, and collecting the droplets in a container. The weight of the collected liquid is measured using an electronic balance or other means, and the weight per droplet is computed by dividing the total weight by the number of droplets
(b) Weight Reduction Method—The weight reduction method measures the weight of the liquid-containing tank before and after the droplets are discharged, and computes the weight per droplet by dividing the difference in weight before and after discharge by the number of droplets.

Measurement of characteristic values pertaining to the viscoelasticity of a droplet is subsequently described. Of the characteristic values of viscoelasticity, viscosity is used in the present embodiment. The relationship between viscosity and the damping constant is used in the measurement of viscosity. When an object that has come in contact with a liquid having viscosity oscillates, the oscillation amplitude of the object is damped by the viscosity of the liquid. The physical property value that shows the relationship between the amplitude and time at this point is the damping constant, and the viscosity and damping constant have a correlation. In the present embodiment, this fact is used to compute the viscosity of a droplet. More specifically, the relationship between the viscosity and the damping constant of a liquid material is obtained in advance by experimentation. Here, liquid material whose relationship between the viscosity and the damping constant is known in advance may be used without experimentation. The damping constant is computed from the change in amplitude of the oscillation that occurs when a droplet deposits on the quartz oscillator 424, and the viscosity that corresponds to this damping constant is computed.

In addition to the above-described methods, the weight and viscosity of a droplet can be computed as described below. FIG. 4 is a diagram showing the structure of a weight and viscosity measuring unit 310. In addition to having the structure of the above-described weight and viscosity measuring unit 150, the weight and viscosity measuring unit 310 has an impedance-computing unit 430.

The quartz oscillator 424 oscillates at a resonance frequency that corresponds to the mass of a droplet in the manner described above, and has a characteristic whereby the resonance frequency changes in accordance with the viscosity of the substance thereof. The weight and viscosity measuring unit 310 makes use of this characteristic and computes the weight and viscosity of the droplet. More specifically, the impedance-computing unit 430 computes the electrical impedance of the quartz oscillator 424 from the relationship between the current and voltage applied to the sensor chip 421. A characteristic of this impedance is that it changes considerably in the vicinity of the resonance frequency. The frequency that is established when the resistance component of the impedance is at its minimum is the resonance frequency, and the resistance component thereof is the resonance resistance value. The impedance computing-unit 430 computes the resonance frequency of the quartz oscillator 424, and a signal that shows the resonance frequency is supplied to the computing unit 423. The frequency counter 422 detects the resonance frequency of the quartz oscillator 424, and supplies a signal that shows the detection result to the computing unit 423. When the computing unit 423 receives the signal showing the resonance frequency that is output from the impedance-computing unit 430 and the signal showing the resonance frequency that is output from the frequency counter 422, the weight and viscosity of the droplet is computed with the aid of a known formula that shows the relationship between the resonance frequency and the mass and viscosity of the droplet.

Thus, the above-described drive waveform-determining device preferably configured and arranged to form a physical property value acquisition section (the weight and viscosity measuring unit 150) for acquiring the physical property values of droplets discharged from the discharge head 110, wherein the basic drive waveform storage section stores a plurality of drive waveforms that correspond to the physical property values of the droplets. The waveform-adjusting section reads from the basic drive waveform storage section those drive waveforms that correspond to the physical property values acquired by the physical property value acquisition section. The waveform storage section also correlates and stores the drive waveforms that are adjusted by the waveform-adjusting section with the physical property values acquired by the physical property value acquisition section. According to the above-described structure, an optimal drive waveform can be determined in accordance with the physical property values of the droplets as discussed below.

The physical property values preferably include at least one of viscosity, surface tension, contact angle, and density. The physical property value acquisition section preferably comprises a section for measuring at least one of the physical property values. According to the above-described structure, the physical property values can be measured by the measuring section even when the physical property values of the liquid materials are not known in advance. The physical property value acquisition section preferably computes the viscosity of the droplets with the aid of the amplitude-damping characteristics of the oscillator when the droplets deposit on the electrode surface.

According to the above-described structure, the viscosity of the droplets can be accurately measured, and an optimal drive waveform can be determined in accordance with the viscosity of the droplets as discussed below.

Measurement of the velocity of a droplet is subsequently described. Measurement of the velocity of a droplet is performed in a dark room with the aid of a CCD (Charge Coupled Device) camera 152a and a strobe light 152b that form a speed-measuring section. The speed-measuring section configured and arranged to measure the velocity of the droplets discharged from the discharge head 110. The CCD camera 152a is disposed in a position that allows a photograph to be taken from a direction that is orthogonal to the discharge direction of the droplet during flight. The analysis unit 154 supplies a timing signal to the CCD camera 152a and the strobe light 152b at a predetermined time interval. When this timing signal is supplied, the photograph taken by the CCD camera 152a and the light emission of the strobe light 152b are performed synchronously. This time interval is set so that a photograph is taken a plurality of times in the interval of time from the discharge of a single droplet until the landing of the droplet on the sensor chip 421. The velocity of the droplet is computed using the position between two points on the image of the photographed droplet, and the time interval in which these are photographed. Thus, in the drive waveform-determining device of the present invention, the speed-measuring section computes the velocity of the droplets by using the position of the droplets discharged from the discharge head at two different points in time, and using the time difference between these two points in time. According to the above-described structure, the velocity of the droplets can be accurately measured, and an optimal drive waveform can be determined in order to allow droplets having a desired velocity of droplet to be discharged.

The above-described measuring method is also used to find variation in the velocity of the droplets. The discharge head 110 has a plurality of nozzles, and there are errors in the output characteristics and dimensions of the nozzles. As a result, variation is generated between the nozzles in the weight of each droplet. It is apparent herein that there is a correlation between the velocity and weight of a droplet when a drive method is used that applies the same waveform to all nozzles, so when the variation in droplet velocity is negligible, the variation in the weight of each droplet is also negligible.

This relationship is used in the present embodiment, and variation in the discharge quantity between nozzles is evaluated by measuring the velocity of the droplets of each nozzle. Evaluation of this variation is described hereinafter.

The methods described herein below may be used to measure the velocity of the droplets. (a) A laser light is emitted so as to pass through two points in the flight path of a droplet, and the intensity of the laser light is measured with a measuring unit that faces the light source. When a droplet is discharged, the laser light is partially blocked by the droplet in flight, so the time at which the droplet passes can be computed by detecting the change in energy at this time. The speed of the droplet can then be computed from the time difference between the time at which passage occurs and the distance between the two points. (b) The time at which a droplet is discharged in known in advance by way of a set value for the drive control unit 120. The time of droplet impact is the same time at which the resonance frequency begins to change in the weight and viscosity measuring unit 150. The velocity of the droplets can be computed from the distance between the upper surface of the sensor chip 421 and the discharge head 110, and the time difference between the two.

### Drive Waveform Determination Procedure

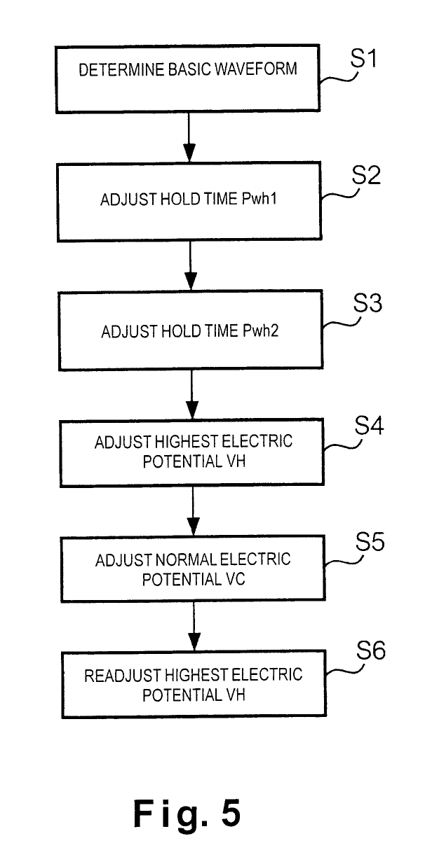

The procedure for determining the drive waveform in which the above-described drive waveform-determining device 100 is used is subsequently described. FIG. 5 is a flow chart showing the processing for determining the drive waveform.

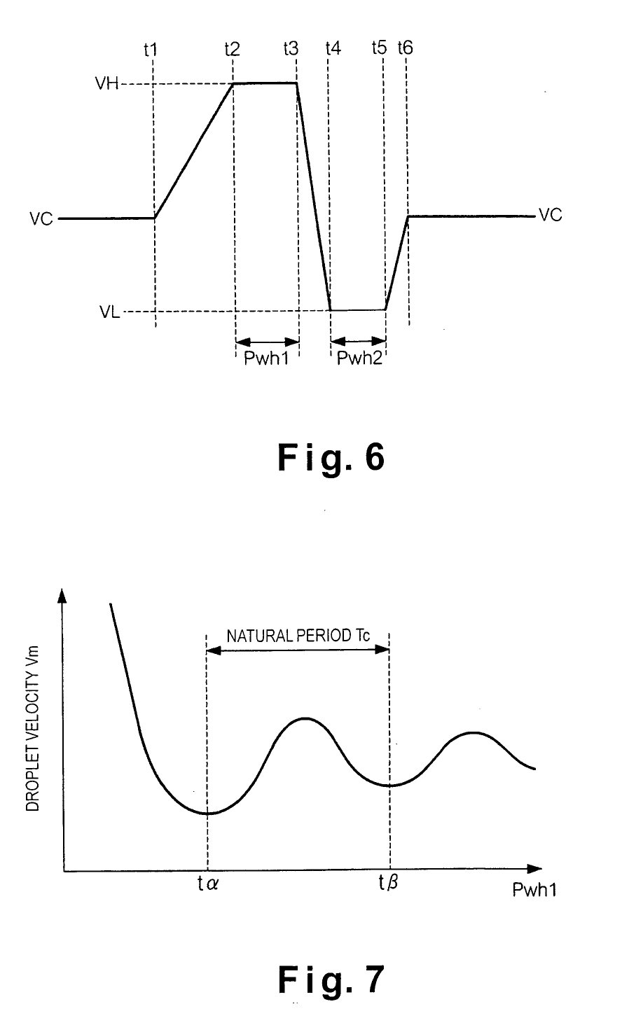

First, the basic waveform is determined as the starting point for determining the drive waveform (step S1). FIG. 6 is a diagram showing an example of a basic drive waveform that is prestored. This basic drive waveform comprises several time intervals that repeat. During a time interval t1 to t2, the basic drive waveform expands the liquid-filled unit of the discharge head 110. During a time interval t2 to t3 (hold time Pwh1), the basic drive waveform maintains the expansion of the liquid-filled unit of the discharge head 10. During a time interval t3 to t4, the basic drive waveform contracts the liquid-filled unit of the discharge head 110. During a time interval t4 to t5 (hold time Pwh2), the basic drive waveform maintains the contraction of the liquid-filled unit of the discharge head 110. During a time interval t5 to t6, the basic drive waveform releases the contraction of the liquid-filled unit of the discharge head 110. During a time interval t6 to t1, the basic drive waveform maintains the initial volume of the liquid-filled unit of the discharge head 110. The discharge head 110 is presented with a normal electric potential VC during the time interval t6 to t1, a highest electric potential VH during the time interval t2 to t3, and a lowest electric potential VL during the time interval t4 to t5.

A parameter or natural period Tc of the discharge head 110 is determined in the manner described below. A droplet is first discharged at a certain velocity by applying a drive voltage having the waveform shown in FIG. 6 to the discharge head 110. This velocity of the droplets changes according to the drive waveform. FIG. 7 is a diagram showing the manner in which the velocity of the droplets varies when the hold time Pwh1 is changed. The horizontal axis is the hold time Pwh1, and the vertical axis is the droplet velocity vm. The droplet velocity vm periodically changes in accordance with the length of the hold time Pwh1, as shown in the diagram. The period tβ to tα of the change in droplet velocity vm at this time is represented by the parameter Tc.

Thus, the waveform-adjusting section also preferably makes corrections in accordance with the natural period Tc of the discharge head 110 to the drive waveform that was read from the basic drive waveform storage section, and adjusts the corrected drive waveform. According to the above-described structure, the basic configuration of the drive waveform can be corrected in accordance with the natural period of the discharge head.

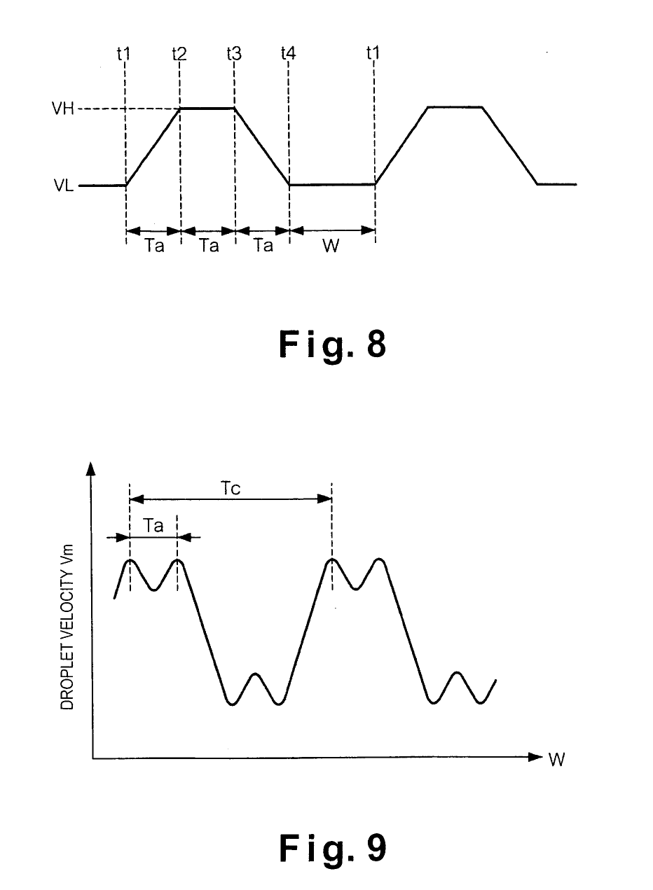

Another parameter Ta, which is used for determining the drive waveform, is subsequently described below. FIG. 8 is a diagram showing an example of an adjusted or corrected drive waveform used when determining parameter Ta. This drive waveform comprises several time intervals that repeat. During a time interval t1 to t2, this drive waveform expands the liquid-filled unit of the discharge head 10. During a time interval t2 to t3 (hold time Pwh1), the drive waveform maintains the expansion of the liquid-filled unit. During a time interval t3 to t4, the drive waveform contracts the liquid-filled unit. During a time interval t4 to t1 (hold time w), the drive waveform maintains the contraction of the liquid-filled unit of the discharge head 110. The time interval t1 to t2, the time t2 to t3, and the time interval t3 to t4 have the same length Ta0, and the time interval t4 to t1 has a length w. The length Ta0 is computed in advance from the design value of the discharge head 110, and is used as the initial value for computing Ta.

The parameter Ta is measured in the manner described below. First, ink is discharged at a certain velocity by applying a drive voltage for the waveform shown in FIG. 8 to the discharge head 110. The velocity of the droplets changes according to the drive waveform.

FIG. 9 is a diagram showing the manner in which the droplet velocity vm varies when the hold time w is changed. The horizontal axis is the hold time w, and the vertical axis is the velocity of the droplets. The velocity of the droplets periodically changes in accordance with the hold time w, as shown in the diagram. This waveform is a composite of a plurality of waveforms, and the period of waveform components can be computed by way of a Fourier analysis. The long period corresponds to the parameter Tc. The short period is the parameter Ta. Accordingly, the basic drive waveform can be adjusted or corrected in accordance with this parameters such that an adjusted or corrected drive waveform is produced for driving the discharge head 110.

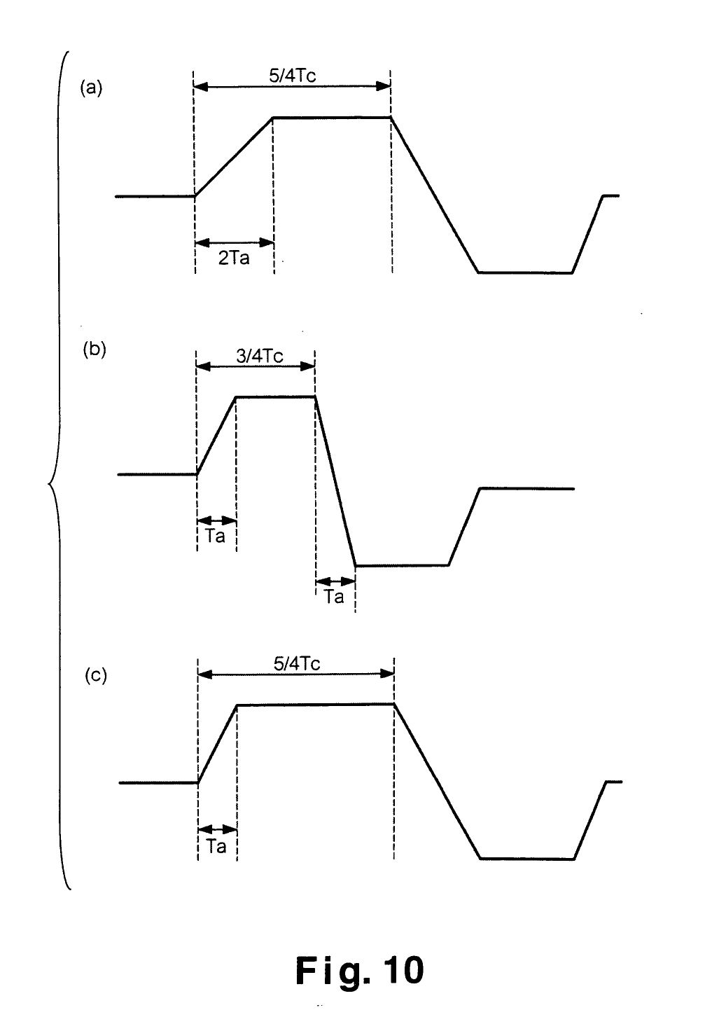

The parameter Tc can be computed by either of the two methods described above, and either one can be used. FIG. 10 is a series of diagrams showing an example of a basic drive waveform created with the aid of the parameters Tc and Ta computed in the manner described above. FIG. 10(a) represents a first candidate for the basic drive waveform. FIG. 10(b) represents a second candidate for the basic drive waveform. FIG. 10(c) represents a third candidate for the basic drive waveform. First, a trial discharge is performed using the first candidate for the drive waveform, and the discharge condition of a droplet is observed by way of an image taken with the CCD camera 152a in the speed-measuring unit 152. If droplets are discharged from all of the plurality of nozzles that are disposed in the discharge head 110, then the first candidate for the drive waveform is adopted as the basic drive waveform for determining the adjusted drive waveform. In the converse case that there is a nozzle from which a droplet is not discharged, then the first candidate is discarded, and a trial discharge is performed using the second candidate for the drive waveform. If droplets are discharged from all of the nozzles with the second candidate for the drive waveform, then the second candidate for the drive waveform is adopted as the basic drive waveform. If there is a nozzle from which a droplet is not discharged with the second candidate for the drive waveform, then the third candidate for the drive waveform is adopted as the basic drive waveform.

The method described below can be used to determine the basic drive waveform that most closely conforms to the current printing conditions. This method first correlates the previously computed drive waveform with the viscosity and stores the data in the analysis unit 154. The viscosity of the droplet is then measured by means of the weight and viscosity measuring unit 150, and an adjusted waveform that most closely conforms to the measured viscosity is selected from among the stored waveforms.

The basic drive waveform is adjusted after being determined as described above. Waveform adjustment is performed by first adjusting the hold time Pwh1 for the highest electric potential (step S2). The hold time Pwh1 is adjusted in the manner shown below.

A droplet is first discharged with the aid of the basic drive waveform selected in step S1, and the droplet velocity of the nozzles is measured by photographing with the CCD camera 152a the droplets discharged from a plurality of nozzles. The velocity of the droplets is measured by changing Pwh1 of the basic drive waveform a number of times. The error (variation) is computed for each nozzle from the target droplet velocity vm, and the mean value δvm thereof is computed. The rate of occurrence (relative variation) δvm/vm of the variation with respect to the speed is computed by dividing the mean value δm of the error by the target droplet velocity vm.

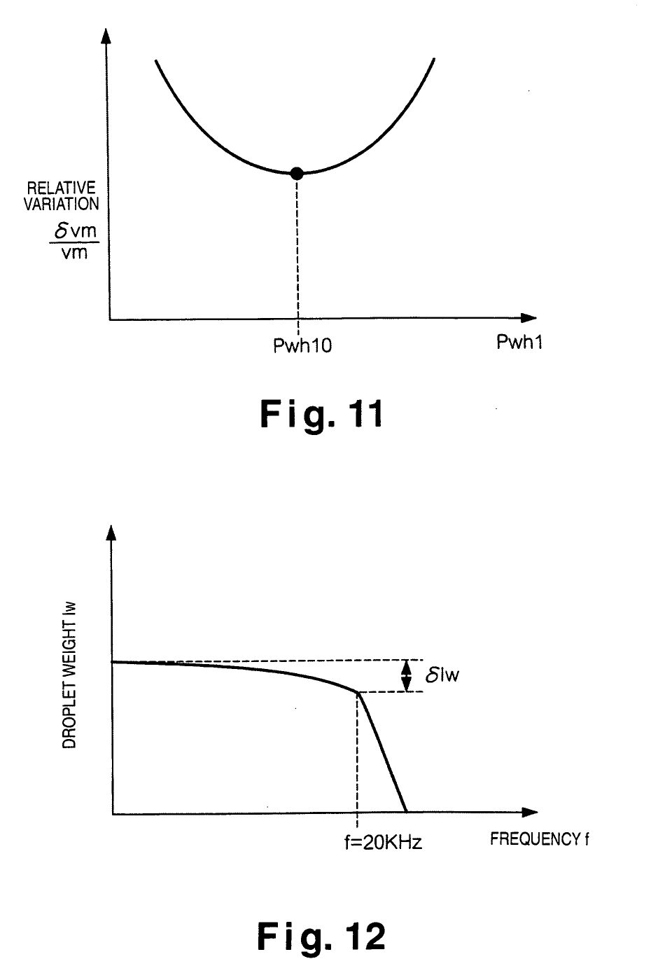

FIG. 11 is a diagram showing the relationship between the hold time Pwh1 and the relative variation δm/vm. The relative variation δvm/vm has a minimum value at hold time Pwhl0, as shown in the diagram. In other words, the relative variation of the velocity of droplet is kept to a minimum by setting the hold time of the highest electric potential to the hold time Pwhl0. Hence, the hold time Pwhl0 is the optimal value of the hold time for the highest electric potential.

The hold time Pwh2 at the lowest electric potential is subsequently adjusted (step S3). The hold time Pwh2 is adjusted with the method described below.

First, a droplet is discharged with the aid of the drive waveform determined in step S2, and the weight of the droplet is measured. The weight measurement is performed by changing the frequency of the drive voltage a number of times. FIG. 12 is a diagram showing the relationship between the frequency f of the drive voltage and the weight Iw of the discharged droplet. The relationship is such that the weight Iw of the droplet becomes smaller as the frequency f of the drive voltage becomes higher, and the weight Iw rapidly decreases when a certain frequency is exceeded, as shown in the diagram. The difference between the maximum value of the weight Iw and the weight when the frequency f is 20 kHz is δIw.

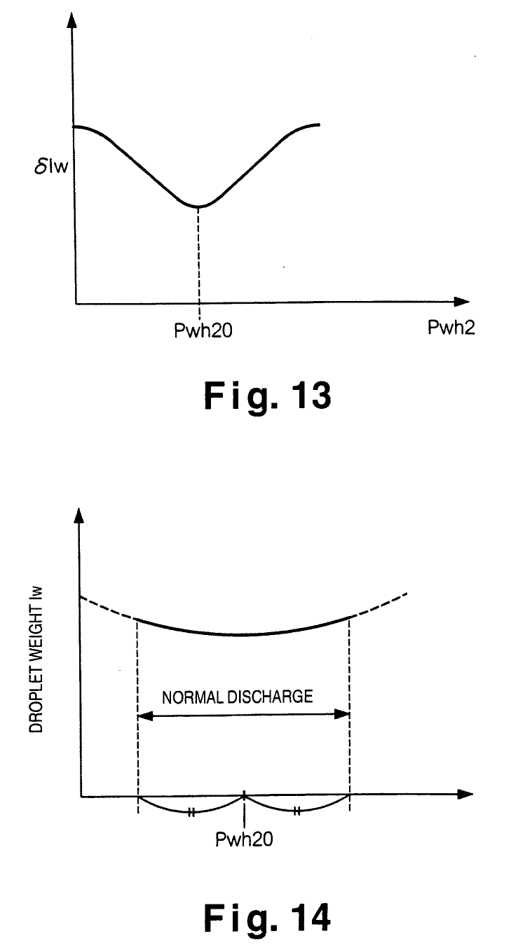

The weight of a droplet is measured in the same manner as described above by changing the hold time Pwh2 a number of times. FIG. 13 is a diagram showing the relationship between δIw and the hold time Pwh2. During the hold time Pwh2, δIw has a minimum value, as shown in the diagram. In other words, the drop in the weight of the droplet is kept at a minimum even at a high frequency by setting the hold time of the lowest electric potential to the hold time Pwh20. Hence, the hold time Pwh20 is the optimal value of the hold time for the lowest electric potential.

It is also possible to use the method described below to adjust the hold time Pwh2 of the lowest electric potential. FIG. 14 is a diagram showing the relationship between the weight Iw of the droplet and the hold time Pwh2. A droplet is discharged in a normal manner when the hold time Pwh2 is within a certain range, and it is apparent that defective discharge occurs when the time is outside of the range. The midpoint of the range of the hold time Pwh2 in which this droplet is discharged in a normal manner may be set as the optimal value of the hold time Pwh20.

The elements of the drive waveform along the time axis are determined in the manner described above. As a result, variation between nozzles can be held in check and a stable droplet weight with respect to the frequency can be ensured as described above. In addition to the above, the electric potential is adjusted with the aim of obtaining the desired droplet weight and droplet velocity in the manner described below.

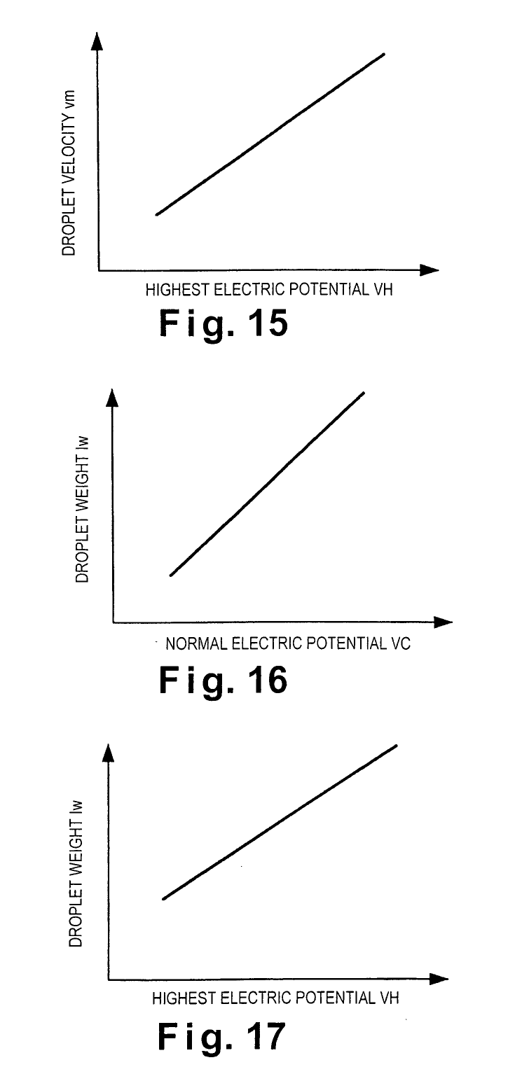

The highest electric potential VH is adjusted first (step S4). The highest electric potential VH is adjusted in the manner described below. A droplet is discharged with the aid of the drive waveform computed in step S3, and the droplet velocity vm of the droplet is measured. Here, the highest electric potential VH is changed a number of times and the droplet velocity vm is measured. FIG. 15 is a diagram showing the relationship between the highest electric potential VH and the droplet velocity vm. The droplet velocity vm of the droplet increases as the highest electric potential VH increases, as shown in the diagram. The highest electric potential VH at which the desired velocity of droplet is obtained is computed from this result.

The normal electric potential VC is subsequently adjusted (step S5). The normal electric potential VC is adjusted in the manner described below. A droplet is discharged with the aid of the drive waveform computed in step S4, and the weight Iw of the droplet is measured. Here, the normal electric potential VC is changed a number of times and the weight Iw of the droplet is measured. FIG. 16 is a diagram showing the relationship between the normal electric potential VC and the weight Iw of the droplet. The weight Iw of the droplet increases as the normal electric potential VC rises, as shown in the diagram. The droplet velocity vm remains constant irrespective of the normal electric potential VC. The normal electric potential VC at which the desired droplet weight is obtained is computed from this result.

The highest electric potential VH is subsequently readjusted (step S6). The highest electric potential VH is readjusted in the manner described below. A droplet is discharged with the aid of the drive waveform computed in step S5, and the weight Iw of the droplet is measured. Here, the highest electric potential VH is changed a number of times and the weight Iw is measured. FIG. 17 is a diagram showing the relationship between the highest electric potential VH and the weight Iw of the droplet. The weight Iw of the droplet increases as the highest electric potential VH increases, as shown in the diagram. The highest electric potential VH at which the desired droplet weight is obtained is computed from this result.

The drive waveform is determined in the manner described above. Because the discharge condition of the droplets also changes according to the temperature of the liquid material, the above-described operation for determining the drive waveform is performed at a plurality of temperature steps within an assumed range. Data that is correlated with the temperature, viscosity, and type of liquid material, and that represents the drive waveform is stored in the analysis unit 154.

In the drive waveform determining device having the above-described structure, the weight measuring section measures the weight of the discharged droplets, and the speed-discharge measuring device measures the velocity of the droplets. The waveform-adjusting section adjusts the drive waveform so that the weight and speed of the droplets match the weight and speed that are stored in the condition storage section, and the waveform storage section stores the adjusted drive waveform.

In the drive waveform determining device having the above-described structure, the waveform-adjusting section preferably determines the normal electric potential and the highest electric potential of the drive waveform so that the weight and velocity of the droplets substantially match the values stored in the condition storage section. According to the above-described structure, the drive waveform can be determined so that a desired weight and velocity can be obtained.

According to the present invention as described above, an exact drive waveform for a droplet discharge device can be determined with few trials. It is possible to accurately make adjustments that reflect the actual discharge conditions, because the velocity and weight of each droplet can be measured. Adjustment can be made accurately in a manner that reflects the actual discharge condition, because the weight and velocity for each droplet can be measured. An optimal waveform can also be selected by storing the drive waveforms. It is possible to select an optimal drive waveform in accordance with the viscosity of a droplet by establishing and storing a correlation between the drive waveform and the viscosity of the droplet.

The discharge head has a plurality of nozzles with the drive waveform being changed to at least one of an early normal electric potential VC, the highest-electric potential VH at expanding the liquid filled unit and the lowest electric potential VL at contracting the liquid-filled unit, and determine a hold time to maintain the electric potential VH of the basic drive waveform so that the variation is minimal; and the waveform-adjusting section preferably measures the variation in the droplet velocity of the plurality of nozzles, and determines the hold time for maintaining the highest electric potential VH of the drive waveform so that the variation is minimal. According to the above-described structure, the drive waveform can be determined so that the variation in the droplet velocity of the plurality of nozzles is minimal.

The waveform-adjusting section is further configured and arranged preferably determine the hold time for maintaining the lowest-electric potential VL of the drive waveform so that the decrease in the weight of the droplets in a high frequency region of the drive waveform is minimal.

According to the above-described structure, the weight of the droplets can be stabilized with respect to changes in the frequency of the drive waveform.

The waveform-adjusting section is further configured and arranged to preferably determine a hold time to maintain the lowest-electric potential VL of the basic drive waveform so that a decrease in the weight of the droplets in a high frequency region of the basic drive waveform is minimal. According to the above-described structure, the drive waveform can be determined so that a desired weight and velocity can be obtained.

The waveform-adjusting section is further configured and arranged to determine the highest electric potential VH and the early normal electric potential VC of the basic drive waveform so that the weight and the velocity of the droplets substantially match the values stored in the condition storage section.

### Modifications

The drive waveform-determining device 100 described in the embodiment above is but one example, and the present invention may be modified in a variety of ways. The above-described embodiment shows an example of a drive waveform-determining device used in conjunction with the droplet discharge device 10, but this drive waveform-determining device can also be incorporated into a droplet discharge device. FIG. 18 is a diagram showing an example of the droplet discharge device 10 in which the drive waveform-determining device 100 has been incorporated. The droplet discharge device 10 is equipped with a head unit 20 with a plurality of nozzles for discharging droplets onto a board 9. A stage 12 is a mounting table for setting the board 9, which is a thin plate composed of paper phenol, glass, or the like.

The table is adapted to allow the head unit 20 to move in the x-direction on a slider 31, and the stage 12 to move in the y-direction on a slider 32. This allows the relative position of the head unit 20 and the board 9 to be adjusted, and droplets to be discharged at any position on the board 9.

According to the above-described structure, the drive waveform-determining device is incorporated into a droplet discharge device, making it possible to quickly determine the drive waveform for discharging droplets at a desired weight and velocity. The drive waveform can also be quickly determined at the production site in accordance with the type of droplet, and production efficiency can be improved.

In the above-described embodiment, voltage of the same waveform is applied to a plurality of nozzles disposed in the discharge head 110, but a voltage having a different waveform may be applied to each nozzle. The waveform adjusting method described above may be used in this case as well, and an optimal waveform can be generated for each nozzle.

The above embodiment was described with reference to a case in which a drive waveform was used to expand and contract a liquid-filled unit of a discharge head and to discharge droplets, but this approach is also applicable to a case in which a drive waveform is used to release the expansion and contraction of the liquid-filled unit of the discharge head (that is, to return to the normal electric potential VC) and to discharge droplets. This approach is also applicable to a drive waveform that is in opposite phase to the drive waveform shown in FIG. 6.

The above embodiment is described with an inkjet device serving as the device for depositing droplets containing a conductive material at predetermined positions on a board 132, but other application examples include printing of forms with colored liquid, manufacture of EL (Electro Luminescence) elements, resist formation, sealing of liquid crystal material and color filter formation on a glass board in a liquid crystal device, manufacture of micro-lens arrays, and discharge of liquids for measuring biological material.

Examples of the inkjet device of present invention include a device that forms a hole-transporting luminescent layer, an electron transport layer, or another layer in an organic EL element; and a layer-forming device for a fluorescent layer in an inorganic EL element. Additional examples of the inkjet device of the present invention include a device for applying a resist in the lithographic step of forming a predetermined conductive film pattern, a device for applying light-transmitting material to a base board that has a plurality of convex portions in the manufacturing of micro-lens arrays, a device for discharging a catalyst for measuring the weight or type of DNA (deoxyribonucleic acid) or another biological material that is injected into a test tube or another container medium, and a device for discharging the biological material itself into a test tube or another medium.

### Electrooptical Devices and Electronic Equipment

Following is a description of an electrooptical device in which a color filter is formed with a droplet discharge device presented with a drive waveform determined by the above-described drive waveform-determining device, and of electronic equipment in which this electrooptical device is used as a display unit.

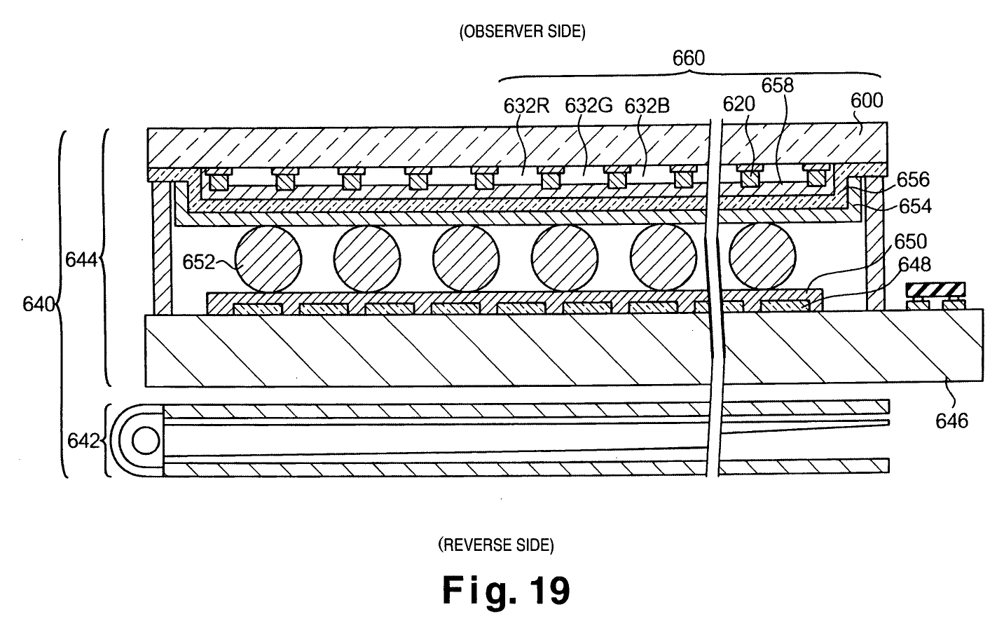

FIG. 19 is a cross-sectional diagram of an electrooptical device having a color filter. The electrooptical device 640 primarily comprises a backlighting mechanism 642 for emitting light toward the observer side, and a passive liquid crystal display panel 644 for selectively transmitting light emitted from the backlighting mechanism 642, as shown in the diagram. Of these, the liquid crystal panel 644 comprises a board 646, electrodes 648, an oriented film 650, spacers 652, an oriented film 654, an electrode 656, and a color filter 660. In the color filter 660, a board 600 is positioned on the upper side (the observer side), as viewed from a partition 620. Red color filters 632R, green color filters 632G, and blue color filters 632B contained in this color filter 660 are patterned by the droplet discharge device of the present invention, and have a thickness that is substantially equal to the design value. An overcoat layer 658 is disposed on the reverse side of the color filters 632R, 632G, and 632B with the aim of protecting these filters.

A liquid crystal is sealed in the gap between the two oriented films 650 and 654 that face each other with the spacers 652 therebetween, and when voltage is applied by the electrodes 648 and 656, the light emitted from the backlighting mechanism 642 is selectively transmitted to each region corresponding to the color filters 632R, 632G, and 632B.

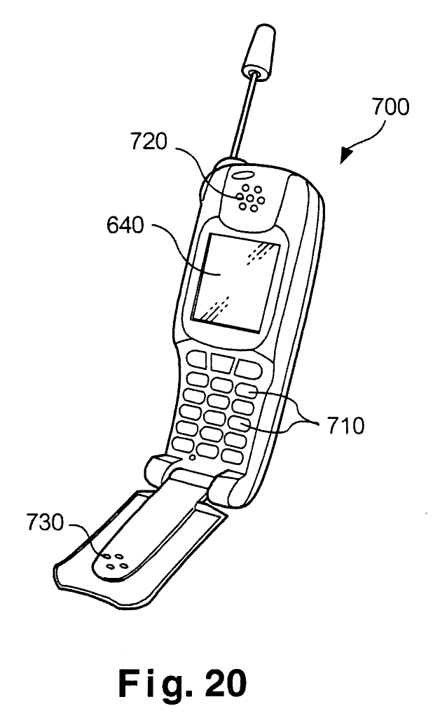

FIG. 20 is a drawing showing the appearance of a portable telephone 700 equipped with the electrooptical device 640. In this drawing, the portable telephone 700 is equipped with a plurality of operating buttons 710 in addition to an earpiece 720, a mouthpiece 730, and an electrooptical device 640 comprising a color filter as the display unit for displaying telephone numbers and a variety of other information. In addition to being used in the portable telephone 700, the electrooptical device 640 manufactured with the droplet discharge device of the present invention may be used as the display unit for computers, projectors, digital cameras, movie cameras, PDAs (Personal Digital Assistant), on-board equipment, copiers, audio equipment, and other electronic equipment.

The term “configured” as used herein to describe a component, section or part of a device includes hardware and/or software that is constructed and/or programmed to carry out the desired function. Moreover, terms that are expressed as “means-plus function” in the claims should include any structure that can be utilized to carry out the function of that part of the present invention. Also the terms of degree such as “substantially”, “about” and “approximately” as used herein mean a reasonable amount of deviation of the modified term such that the end result is not significantly changed.

This application claims priority to Japanese Patent Application Nos. 2003-048146, 2003410555 and 2004-035541. The entire disclosures of Japanese Patent Application Nos. 2003-048146, 2003410555 and 2004-035541 are all hereby incorporated herein by reference.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents. Thus, the scope of the invention is not limited to the disclosed embodiments.

1. A drive waveform-determining device comprising:
a condition storage section configured and arranged to store an optimal weight and velocity of droplets to be discharged from a discharge head;
a weight measuring section configured and arranged to measure the weight of the droplets discharged from the discharge head;
a speed-measuring section configured and arranged to measure the velocity of the droplets discharged from the discharge head;
a basic drive waveform storage section configured and arranged to store a basic drive waveform;
a waveform-adjusting section configured and arranged to read the basic drive waveform from the basic drive waveform storage section and adjust the basic drive waveform to an adjusted drive waveform so that the weight that is measured by the weight measuring section and the velocity that is measured by the speed-measuring section substantially match the optimal weight and velocity that are stored in the condition storage section for the adjusted drive waveform; and
an adjusted waveform storage section configured and arranged to store the adjusted drive waveform that is adjusted by the waveform-adjusting section.

2. The drive waveform-determining device according to claim 1, further comprising
a physical property value acquisition section configured and arranged to acquire physical property values of the droplets discharged from the discharge head,
the basic drive waveform storage section being further configured and arranged to store a plurality of basic drive waveforms that correspond to the physical property values of the droplets,
the waveform-adjusting section being further configured and arranged to read one of the basic drive waveforms from those stored in the basic drive waveform storage section as the adjusted drive waveform that correspond to the physical property values acquired by the physical property value acquisition section, and
the adjusted waveform storage section being further configured and arranged to correlate and store the adjusted drive waveforms that are adjusted by the waveform-adjusting section with the physical property values acquired by the physical property value acquisition section.

3. The drive waveform-determining device according to claim 1, wherein
the waveform-adjusting section is further configured and arranged to correct the basic drive waveform that was read from the basic drive waveform storage section in accordance with a natural period of the discharge head, and adjust the basic drive waveform.

4. The drive waveform-determining device according to claim 2, wherein
the physical property value acquisition section is further configured and arranged to acquire at least one of viscosity, surface tension, contact angle, and density as the physical property values of the droplets.

5. The drive waveform-determining device according to claim 4, wherein
the physical property value acquisition section comprises a measuring section that is configured and arranged to measure at least one of physical property of the droplets.

6. The drive waveform-determining device according to claim 1, wherein the weight measuring section comprises:
an electrode configured and arranged to face the discharge head,
an oscillator configured and arranged to change frequency in accordance with the weight of a substance deposited on an electrode surface,
a frequency counter configured and arranged to measure the frequency of the oscillator, and
a calculating section configured and arranged to calculate the weight of the droplets on the basis of the difference in frequency before and after droplet deposition measured with the aid of the frequency counter.

7. The drive waveform-determining device according to claim 5, wherein
the physical property value acquisition section is further configured and arranged to compute a viscosity of the droplets with aid of an amplitude-damping characteristics of the oscillator when the droplets deposit on the electrode surface.

8. The drive waveform-determining device according to claim 1, wherein
the speed-measuring section is further configured and arranged to compute the velocity of the droplets by using the position of the droplets discharged from the discharge head at two different points in time, and using the time difference between these two points in time.

9. The drive waveform-determining device according to claim 1, wherein
the waveform-adjusting section is further configured and arranged to measure a variation in the velocity of the droplets from a plurality of nozzles of the discharge head,
the waveform-adjusting section is further configured and arranged to change the drive waveform by using at least one of an early electric potential VC, an electric potential VH during expanding a liquid filled unit of the discharge head and an electric potential VL during contracting the liquid-filled unit of the discharge head, and
the waveform-adjusting section is further configured and arranged to determine a hold time to maintain the electric potential VH of the basic drive waveform so that the variation is minimal.

10. The drive waveform-determining device according to claim 1, wherein
the waveform-adjusting section is further configured and arranged to determine a hold time to maintain an electric potential VL of the basic drive waveform so that a decrease in the weight of the droplets in a high frequency region of the basic drive waveform is minimal.

11. The drive waveform-determining device according to claim 1, wherein
the waveform-adjusting section is further configured and arranged to determine an electric potential VH and an early electric potential VC of the basic drive waveform so that the weight and the velocity of the droplets substantially match the values stored in the condition storage section.

12. A droplet discharge device comprising:
a discharge head equipped with a liquid-filled unit containing a liquid material and configured and arranged to form the liquid material into droplets;
a drive control section configured and arranged to supply a drive waveform to the discharge head to discharge the droplets by expanding or contracting the liquid-filled unit in accordance with the drive waveform; and
a drive waveform-determining device comprising:
a condition storage section configured and arranged to store an optimal weight and velocity of droplets to be discharged from the discharge head;
a weight measuring section configured and arranged to measure the weight of the droplets discharged from the discharge head;
a speed-measuring section configured and arranged to measure the velocity of the droplets discharged from the discharge head;
a basic drive waveform storage section configured and arranged to store a basic drive waveform;
a waveform-adjusting section configured and arranged to read the basic drive waveform from the basic drive waveform storage section and adjust the basic drive waveform to an adjusted drive waveform so that the weight that is measured by the weight measuring section and the velocity that is measured by the speed-measuring section substantially match the optimal weight and velocity that are stored in the condition storage section for the adjusted drive waveform; and
an adjusted waveform storage section configured and arranged to store the adjusted drive waveform that is adjusted by the waveform-adjusting section.
the drive control section being configured to provide the discharge head with the adjusted drive waveform that is determined by the drive waveform-determining device.

13. The droplet discharge device according to claim 12, further comprising
a physical property value acquisition section configured and arranged to acquire physical property values of the droplets discharged from the discharge head,
the basic drive waveform storage section being further configured and arranged to store a plurality of basic drive waveforms that correspond to the physical property values of the droplets,
the waveform-adjusting section being further configured and arranged to read one of the basic drive waveforms from those stored in the basic drive waveform storage section as the adjusted drive waveform that correspond to the physical property values acquired by the physical property value acquisition section; and
the adjusted waveform storage section being further configured and arranged to correlate and store the adjusted drive waveforms that are adjusted by the waveform-adjusting section with the physical property values acquired by the physical property value acquisition section.

14. The droplet discharge device according to claim 12, wherein
the waveform-adjusting section is further configured and arranged to correct the basic drive waveform that was read from the basic drive waveform storage section in accordance with a natural period of the discharge head, and adjust the basic drive waveform.

15. The droplet discharge device according to claim 12, wherein
the speed-measuring section is further configured and arranged to compute the velocity of the droplets by using the position of the droplets discharged from the discharge head at two different points in time, and using the time difference between these two points in time.

16. The droplet discharge device according to claim 12, wherein
the waveform-adjusting section is further configured and arranged to measure a variation in the velocity of the droplets from a plurality of nozzles of the discharge head,
the waveform-adjusting section is further configured and arranged to change the drive waveform by using at least one of an early electric potential VC, an electric potential VH during expanding a liquid filled unit of the discharge head and an electric potential VL during contracting the liquid-filled unit of the discharge head, and
the waveform-adjusting section is further configured and arranged to determine a hold time to maintain the electric potential VH of the basic drive waveform so that the variation is minimal.

17. The droplet discharge device according to claim 12, wherein
the waveform-adjusting section is further configured and arranged to determine a hold time to maintain an electric potential VL of the basic drive waveform so that a decrease in the weight of the droplets in a high frequency region of the basic drive waveform is minimal.

18. The droplet discharge device according to claim 12, wherein
the waveform-adjusting section is further configured and arranged to determine an electric potential VH and an early electric potential VC of the basic drive waveform so that the weight and the velocity of the droplets substantially match the values stored in the condition storage section.

19. An electrooptical device manufactured using the droplet discharge device according to claim 12.

20. An electronic equipment equipped with an electrooptical device manufactured using the droplet discharge device according to claim 12.
